(19) United States
(12) Patent Application Publication
(10) Pub. No.: US 2021/0363754 A1
(43) Pub. Date: Nov. 25, 2021

(54) FACING BUILDING MEMBER

(71) Applicant: TECTONIC FACADES LTD, Staffordshire (GB)

(72) Inventor: Harvey Richard THORP, Stafford Staffordshire (GB)

(21) Appl. No.: 17/043,513

(22) PCT Filed: Mar. 29, 2019
(86) PCT No.: PCT/GB2019/050939

§ 371 Date: Sep. 29, 2020

(30) Foreign Application Priority Data
Mar. 29, 2018 (GB) 1805184.7

(51) Int. Cl. E04C 2/52; E04C 1/40; E04C 2/04; E04F 13/08; E04F 13/14; B26F 3/00; E04B 2/02; E04C 2/06

(52) U.S. Cl. CPC E04C 2/526; E04C 1/40; E04C 2/041; E04F 13/0862; E04C 2002/007; B26F 3/004; E04B 2/02; E04C 2/06; E04F 13/142

(57) ABSTRACT

A facing building member, a method of forming a facing building member and a method of forming a cladding panel. The facing building member is usable with other building members in forming a cladding panel. The building member has a front face and a rear side, the rear side being profiled by cutting with a water jet so as to provide at least one mechanical key on the facing building member.

This invention concerns a building member and particularly a facing building member usable in forming a cladding panel, a method of forming a facing building member, and a method of forming a cladding panel.

Cladding is widely used on buildings to provide an aesthetically pleasing exterior to the building. A wide variety of facing materials can be used to provide a required finish. One type of cladding includes a plurality of facing building members mounted in a required pattern on a cementitious backing layer. The building members are often bricks, though many other types of building members can be used.

With brick facing members, “brick slips” are often used which are relatively thin bricks, which can be formed by cutting conventional bricks for instance into two brick slips. Where bricks are cut this is generally achieved using a diamond tipped saw which inter alia often leaves a layer of dust or slurry upon the cut bricks which can affect their adhesion to the backing layer. Cutting conventional bricks enables any required bricks to be used, such that for instance local bricks can be used to match with existing buildings and structures.

Difficulties can though be encountered in providing a good bond between the brick slips and the cementitious backing layer and also between adjacent brick slips, and especially at the peripheral edges of the cladding where the brick slips may only have two other adjacent brick slips to bond to.

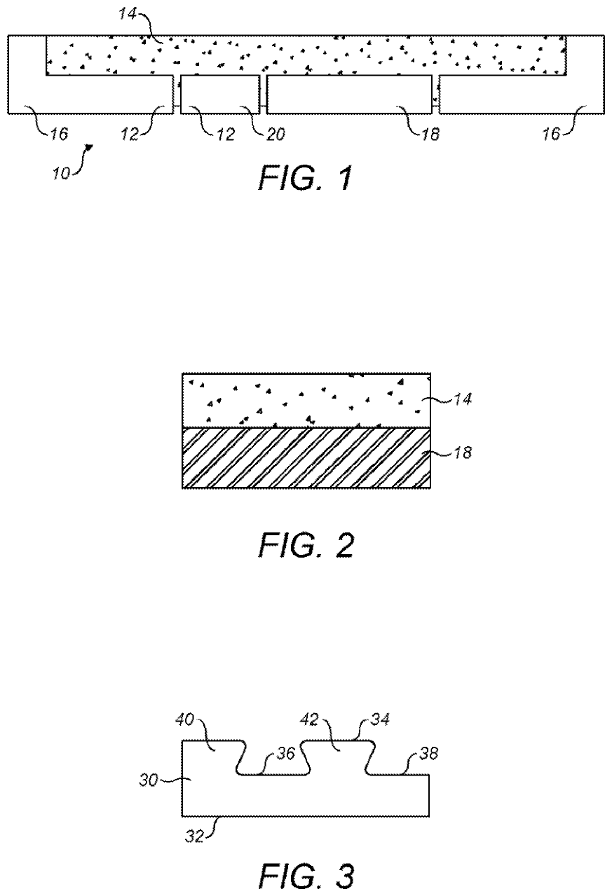

FIG. 1 diagrammatically shows a plan view of a conventional cladding panel 10 with brick slips 12 mounted on a cementitious backing layer 14. The brick slips comprise two corner members 16 referred to as “pistols”, a full length brick 18, a “stretcher”, and a half length brick 20, a “header”. As can be seen the mechanical key between the cementitious material 14 and the brick slips 12 is provided between the cementitious material 14 on the rear faces of the brick slips 12, and also between the cementitious material 14 located between adjacent brick slips 12, where the cementitious material 14 has flowed between the brick slips 12. Often the cementitious material 14 will not flow as far between the brick slips as is shown diagrammatically in FIG. 1.

FIG. 2 shows a conventional stretcher brick slip 18 with a layer of cementitious material therebehind 14.

In the specification the term “mechanical key” on a building member is to be understood as a formation which prevents there being a direct line of sight perpendicularly from the rear of a front face of the building member, to a rear of the building member, at any point.

According to a first aspect of the invention there is provided a facing building member usable with other building members in forming a cladding panel, the building member having a front face and a rear side, the rear side being profiled by cutting with a water jet so as to provide at least one mechanical key on the facing building member.

A plurality of mechanical keys may be provided on the facing building member. The mechanical keys may be provided by recesses in the rear side of the facing building member, and the or each recess may provide more than one mechanical key.

At least one pair of mechanical keys may be provided with edges inclined relative to the front face, with the pair having one edge inclined relative to the front face in a first direction, and a second edge inclined relative to the front facing and opposite second direction.

The pair of mechanical keys may be provided by a recess with a dovetail profile in plan view relative to the front face. The dovetail profile may have rounded edges.

The facing building member may be in the form of a brick facing member, and may be formed by cutting a brick into two or more parts.

The or each recess may extend from between 10 and 60% of the thickness of the facing building member, and more particularly between 25 and 45% of the thickness of the facing building member.

The rear side of the facing building member may have a regular pattern of recesses, and the recesses may be separated by correspondingly profiled projections.

The rear side of the facing building member may have a recess which extends to one end of the building member, and preferably such a recess only at one end of the facing building member.

The profile of the rear side may be configured with an inclination such that the distance between the rear side and the front face decreases in one or more directions across the building member.

The facing building member may be in the form of a corner member with a front face and a side face, with at least one mechanical key on the rear side from the front face. A mechanical key may also be provided on the rear side of the side face.

According to a further aspect of the invention there is provided a method of forming a facing building member, the method comprising cutting an original building member with a water jet to form a facing building member with a front face and a profiled rear side with at least one mechanical key on the rear side.

A solid abrasive may be provided in the water jet, which abrasive may be garnet.

The original building member may be cut into two or more pieces so as to provide two or more facing building members, with opposite sides of the original member providing the respective front faces, and the respective rear sides being provided by a cut through the original building member.

The original building member may be cut so as to provide two substantially identical facing building members.

The original building member may be a brick, and may be a moulded clay brick.

According to a still further aspect of the invention there is provided a method of forming a cladding panel, the method comprising forming a plurality of facing building members according to any of the preceding paragraphs, locating the building members in a required pattern in a mould, locating a settable material onto the rear of the facing building members to form a panel once set.

The settable material may be cementitious, may be ultra high performance concrete, which may be fibre reinforced.

Embodiments of the present invention will now be described by way of example only and with reference to the accompanying drawings, in which:

FIG. 1 is a diagrammatic plan view of a conventional cladding panel according to the invention;

FIG. 2 is a diagrammatic plan view of part of a conventional cladding panel according to the invention;

FIG. 3 is a diagrammatic plan view of a first building member according to the invention;

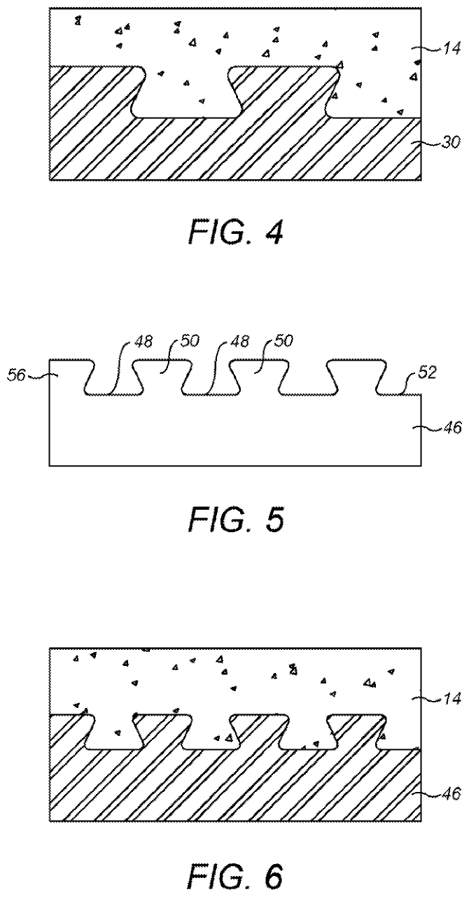

FIG. 4 is a similar view to FIG. 2 but showing the member of FIG. 3;

FIG. 5 is a similar view to FIG. 3 but of a second building member according to the invention;

FIG. 6 is a similar view to FIG. 4 but including the building member of FIG. 5;

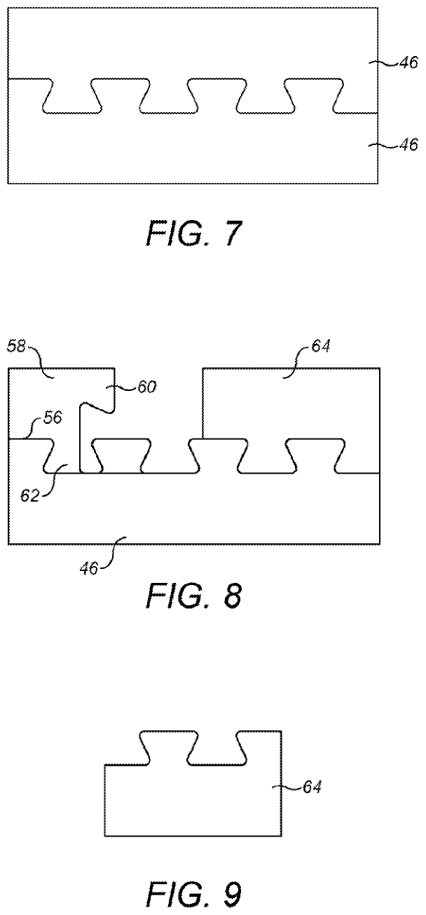

FIG. 7 is a diagrammatic view illustrating forming of the building member of FIG. 5;

FIG. 8 is a similar view to FIG. 7 diagrammatically showing the forming of further building members according to the invention;

FIGS. 9, 10 and 11 are similar views to FIG. 3 but of further building members according to the invention

FIGS. 12 to 14 show potential use of building members according to the invention; and

FIG. 15 is a similar view to FIG. 1 but showing building members according to the invention.

FIGS. 3 to 15 all show building members according to the invention. These building members are formed by cutting a moulded clay brick to a required profile using a high pressure water jet with a solid abrasive medium such as garnet in the water flow. The water jet may be CNC controlled to permit automatic and accurate profiling.

FIGS. 3 and 4 show a first facing building member 30 which has a front face 32 and a rear side 34. The rear side 34 has a profile comprising a complete rounded dovetail shape recess 36 in plan view, and a second partial rounded dovetail shape recess 38 which extends to one end, the right hand end as shown of the member 30. The two recesses 36, 38 are separated by correspondingly profiled rounded dovetail shape projections 40, 42, one 40 of which is only partial and extends to the left hand end as shown of the building member 30.

It is to be realised that the building member 30 can be cut from a single brick to provide two identical building members 30. This building member 30 is suitable for use in half bond brickwork and will provide significantly enhanced bonding between the building member and cementitious material 44, for instance as shown in FIG. 4. This is due to the larger contact surface area between the member 30 and cementitious material 44, and the mechanical keys 46 formed by the recess 36, 38 and respective projections 40, 42.

FIGS. 5 and 6 show a further facing building member 46 which is similar to the building member 30 but is suitable for use in quarter bond brickwork and therefore includes essentially double the number of recesses 48 and projections 50 relative to the building member 30. As can be seen there are three full dovetail recesses 48, and a further one 52 which extends to the right hand end of the building member 46. Similarly, three full dovetail profile projections 50 are provided, with a further projection 56 extending to the left hand end. Again, this building member 46 can be cut from a single brick to provide two identical building members 46 as illustrated in FIG. 7.

FIG. 8 diagrammatically illustrates how a brick could be cut into three building members using quarter bond brickwork. The first being the building member 46, a second being a short member 58 usable in forming a corner, with a dovetail profiled projection 60 at one end, and a dovetail profiled other end 62 to permit joining to a dovetail part shape projection 56 on another building member 46. A third building member 64 is provided which is equivalent to a half brick, i.e. a header. As can be seen this building member 64 extends for a little under a half of the length of the building member 46, to provide a space for the cementitious material to extend between adjacent building members. FIG. 9 shows this building member 64.

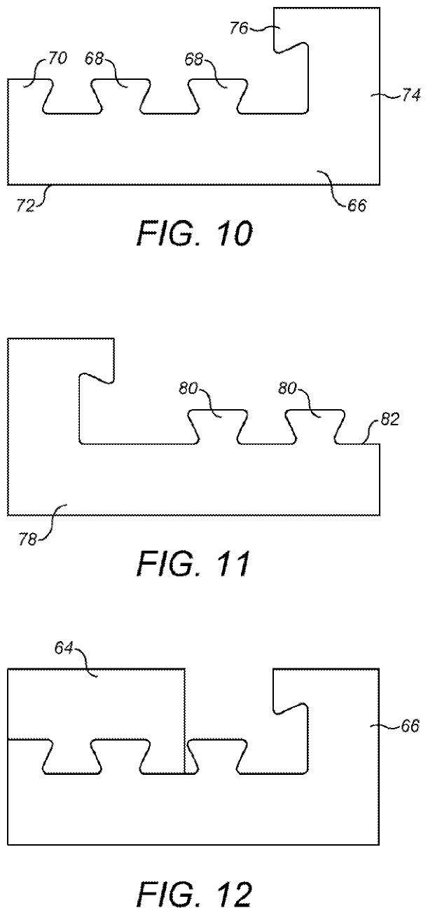

FIG. 10 shows a further building member 66 usable as a corner or pistol with two full 68 and one part dovetail shape projection 70 on the rear of the front face 72, and a side face 74 with part of a dovetail shape projection 76 at the end thereof.

FIG. 11 shows a similar corner member 78, but in this instance only two full dovetail shape projections 80 are provided such that a dovetail shape recess 82 extends to the right hand end as shown.

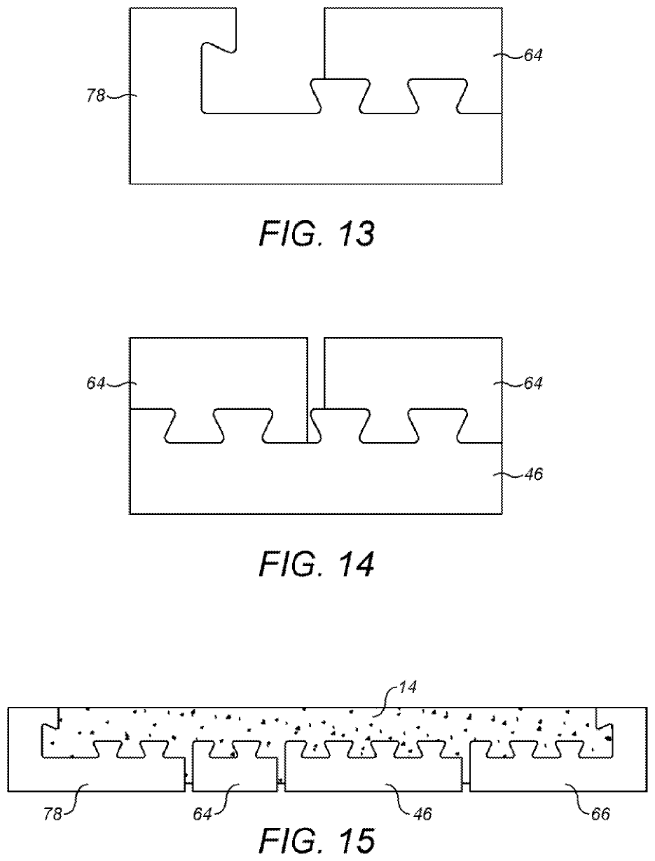

FIGS. 12 and 13 respectively show the corner building members 66, 78 connected to the half brick building member 64, with the orientation of the half brick building member 64 determined by which of the corner building members 66, 78 is used, depending on the orientation of the corner.

FIG. 14 shows the stretcher building member 46 with two half brick building members 64 located thereon, illustrating the gap provided between the half brick building members 64 to enable cementitious material to locate therebetween in a conventional manner, relative to mortar used to join bricks together.

FIG. 15 is a similar view to FIG. 1 but showing use of building members 78, 64, 46, 66 according to the invention. This illustrates the significantly increased surface area of the join between the cementitious material 44 and the building members 78, 64, 46, 66. As also can be seen the join between adjacent building members 78, 64, 46, 66 is provided between a part recess and a part projection which permits cementitious material 44 to extend further between the adjacent building members 78, 64, 46, 66 to provide a strong bond therebetween.

As can be seen a wide range of profiles or building members can be produced as required, and multiple building members can be provided from each brick. The building members may be cut to suit particular bond types and corner details.

The above described examples therefore provide a system for significantly enhanced bonding between the cementitious material and building members due to the increased surface area of the contact surface therebetween, and the mechanical keys. The use of the water jet cutting permits different profiles to be achieved with a greater surface area of contact faces between the cementitious material and the building members. The water jet cutting exposes the rough nature of the bricks providing a positive keying thereto of the cementitious material. The water jet cutting also removes any slurry from the surface of the brick in contrast to sawing. The rounded edges of the dovetail profile allows the cementitious material to flow around corners to fill voids, and to avoid trapped air which can occur with sharply angled corners. This cutting readily permits computer control for automatic cooperation whilst providing consistent profiles.

It is to be realised that a wide range of modifications may be made without departing from the scope of the invention. A different abrasive such as said may be used. For instance, the building members may gently diverge in one or both directions to provide increased bonding, with the rear side of the building members being cut at an inclination. The recesses and projections may have a different profile. Whilst the above invention is described in relation to bricks, other building members could be cut in this way.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A facing building member usable with other building members in forming a cladding panel, the building member having a front face and a rear side, the rear side being profiled by cutting with a water jet so as to provide at least one mechanical key provided by a recess in the rear side of the facing building member.

2. (canceled)

3. A facing building member as claimed in claim 1, wherein a plurality of mechanical keys are provided by recesses in the rear side of the facing building member.

4. A facing building member as claimed in claim 3, wherein each of the recesses provides more than one mechanical key.

5. A facing building member as claimed in claim 1, wherein at least one pair of mechanical keys are provided with edges inclined relative to the front face, with the pair of mechanical keys having one edge inclined relative to the front face in a first direction, and a second edge inclined relative to the front face and in an opposite second direction.

6. A facing building member as claimed in claim 5, wherein the pair of mechanical keys are provided by a recess with a dovetail profile in plan view relative to the front face.

7. (canceled)

8. A facing building member as claimed in claim 1, wherein the facing building member is in the form of a brick facing member, and may be formed by cutting a brick into two or more parts.

9. A facing building member as claimed in claim 3, wherein each of the recesses extends from between 10 and 60% of the thickness of the facing building member.

10. (canceled)

11. A facing building member as claimed in claim 3, wherein the rear side of the facing building member has a regular pattern of recesses, and wherein the recesses are separated by correspondingly profiled projections.

12. A facing building member as claimed in claim 3, wherein the recesses are separated by correspondingly profiled projections.

13. A facing building member as claimed in claim 3, wherein the rear side of the facing building member has a recess which extends to one end of the building member.

14. (canceled)

15. A facing building member as claimed in claim 1, wherein the profile of the rear side is configured with an inclination such that the distance between the rear side and the front face decreases in one or more directions across the facing building member.

16. A facing building member as claimed in claim 1, wherein the facing building member is in the form of a corner member with a front face and a side face, with at least one mechanical key on the rear side from the front face.

17. (canceled)

18. A method of forming a facing building member, the method comprising cutting an original building member with a water jet to form a facing building member with a front face and a profiled rear side, wherein the cutting provides the profiled rear side with at least one mechanical key on the rear side.

19. A method as claimed in claim 18, wherein a solid abrasive is provided in the water jet.

20. (canceled)

21. A method as claimed in claim 18, wherein the original building member is cut into two or more pieces so as to provide two or more facing building members, with opposite sides of the original member providing the respective front faces, and the respective rear sides being provided by a cut through the original building member.

22. A method as claimed in claim 18, wherein the original building member may be cut so as to provide two substantially identical facing building members.

23. (canceled)

24. (canceled)

25. A method of forming a cladding panel, the method comprising forming a plurality of facing building members according to claim 1, locating the building members in a required pattern in a mould, locating a settable material onto the rear of the facing building members to form a panel once set.

26. A method as claimed in claim 25, wherein the settable material is cementitious.

27. A method as claimed in claim 25, wherein the settable material is ultra high performance concrete.

28. A method as claimed in claim 26, wherein the settable material is fibre reinforced.
